(19) United States
(12) Patent Application Publication
(10) Pub. No.: US 2008/0124253 A1
(43) Pub. Date: May 29, 2008

(54) Fluidized-Bed Reactor For The Thermal Treatment Of Fluidizable Substances In A Microwave-Heated Fluidized Bed

(76) Inventors: Achim Schmidt, Bayreuth (DE); Marcus Runkel, Partenheim (DE)

Correspondence Address: MORGAN & FINNEGAN, L.L.P., 3 WORLD FINANCIAL CENTER, NEW YORK, NY, 10281-2101, US

(21) Appl. No.: 11/574,208

(22) PCT Filed: Aug. 11, 2005
(86) PCT No.: PCT/EP05/08713

§ 371 Date: Sep. 26, 2007

(30) Foreign Application Priority Data
Aug. 31, 2004 (DE) 10 2004 042 430.6

(51) Int. Cl. B01J 19/02

(52) U.S. Cl. 422/146

(57) ABSTRACT

The present invention relates to a fluidized-bed reactor for the thermal treatment of fluidizable substances, comprising at least one means for feeding microwave radiation into the fluidized-bed reactor and a metallic reactor wall defining the reactor and having a thermal insulation coating. To increase the energy utilization of such reactors, it is proposed in accordance with the invention that the thermal insulation coating is provided on the inside of the reactor wall and has an outer layer as seen from the reactor wall, which comprises refractory brick and/or refractory concrete as well as an inner layer comprising light-weight refractory brick and/or insulating concrete.

### TECHNICAL FIELD

The present invention relates to a fluidized-bed reactor for the thermal treatment of fluidizable substances, comprising at least one means for feeding microwave radiation into the fluidized-bed reactor, and a metallic reactor wall which defines the reactor and has a thermal insulation coating.

Methods and reactors for the thermal treatment of fluidizable substances in a fluidized bed by utilizing microwave radiation as a source of energy without thermal insulation of the reactor wall are known for instance from U.S. Pat. No. 5,972,302. However, the corresponding methods and reactors are characterized by a comparatively low utilization of energy due to the lack of thermal insulation.

To increase the efficiency, U.S. Pat. No. 5,382,412 therefore proposes a plant for producing polycrystalline silicon, comprising a fluidized-bed reactor thermally operated with microwave energy, in which on the outside of the reactor wall a thermal insulation coating of inorganic materials is provided. In this plant, however, it must be ensured by a special selection of the material of the reactor wall or by an additional coating on the inside of the reactor wall that the inside of the reactor wall is abrasion-resistant, in order to prevent an abrasion of the inside of the reactor wall by the substances to be fluidized during operation of the reactor.

Therefore, there is a need for microwave-heated fluidized-bed reactors for the thermal treatment of fluidizable substances, whose inner reactor walls connected with the reactor interior penetrated by the microwaves are equipped with an abrasion-resistant and thermally insulating coating.

There have already been proposed apparatuses suitable for other uses, whose interior is provided with microwave-transparent, thermally insulating coatings. Due to their special requirements, the same are, however, not suited for fluidized-bed reactors. From DE 44 46 531 A1 there is known for instance a microwave-operated sintering means, whose interior is equipped with a thermal insulation coating formed of fibers, foams or aerogels and consisting of microwave-transparent materials. As microwave-transparent materials, there are used oxidic materials with α-alumina and with a siliceous content of up to 50 wt-%, which must, however, be free of impurities, in order to avoid a heating and melting of the insulation material by the microwaves. Due to the required high purity of the insulating materials and the related costs, the same are not suited for large-scale commercial plants, such as fluidized-bed reactors. Apart from this, the aforementioned materials cannot be used on the inside of fluidized-bed reactors, because they are not abrasion-resistant.

### DESCRIPTION OF THE INVENTION

Therefore, it is the object of the present invention to provide a fluidized-bed reactor for the thermal treatment of fluidizable substances, whose inner reactor wall is provided with a rather light-weight, abrasion-resistant, microwave-transparent, heat-resistant and thermally insulating coating, which is also rather inexpensive.

In accordance with the invention, this object is solved by a fluidized-bed reactor as mentioned above, in which the thermal insulation coating includes an outer layer as seen from the reactor wall, which comprises refractory brick and/or refractory concrete, as well as an inner layer comprising light-weight refractory brick and/or insulating concrete, and the same is provided on the inside of the reactor wall.

In accordance with the present invention, it could surprisingly be found that the light-weight refractory bricks, insulating concrete, refractory concrete and refractory bricks used for quite some time for lining combustion chambers of chimney furnaces and heating cassettes are sufficiently microwave-transparent in the sequence of layers provided in accordance with the invention, in particular have a sufficiently low specific energy absorption, in order to be useful as thermal insulation for fluidized-bed reactors. Due to the sufficiently high hardness and abrasion resistance of the refractory brick and/or refractory concrete provided in the outer layer of the insulation coating as seen from the reactor wall, the thermal insulation coating can be provided on the inside of the reactor, which leads to a high utilization of energy of the fluidized-bed reactors. Due to the low density of the light-weight refractory brick and/or insulating concrete provided in the inner layer of the insulation coating as seen from the reactor wall, the thermal insulation coating also has a comparatively low total weight. In addition, the present invention is based on the knowledge that in contrast to what has been described in the prior art, the microwave-transparent insulation coating can definitely also contain considerable amounts of iron oxide and calcium oxide, unless both components are each present in an amount of more than 1.5 wt-%. The insulation coatings in accordance with the invention are characterized by a high thermal stability and can be used in particular for a reactor operation in the range from 400° C. to 1300° C.

In accordance with the invention, the thermal insulation coating can be provided directly on the inner reactor wall or on a layer of aluminum silicate or calcium silicate disposed on the inner reactor wall. In the latter case, the thickness of the aluminum silicate layer or calcium silicate layer preferably is between 20 and 100 mm, particularly preferably between 30 and 70 mm, and quite particularly preferably about 50 mm. To compensate possible stresses resulting from the different thermal expansions of the thermal insulation on the one hand and the reactor shell on the other hand, a binding layer containing less than 2 wt-% Fe2O3 and CaO can additionally be disposed between the thermal insulation and the reactor wall.

In principle, all kinds of commercially available refractory bricks can be provided in the outer layer, particularly good results being obtained, however, when the refractory brick used contains
40 to 50 wt-% alumina
45 to 55 wt-% silica
1.5 to 2.2 wt-% iron oxide, and
0 to 1 wt-% calcium oxide.

Furthermore, refractory brick with a density of 2.2 to 2.6 kg/dm³ is preferred. Quite particularly good results are obtained when the outer layer comprises refractory brick which contains
45 wt-% alumina
53 wt-% silica
2 wt-% iron oxide, and
0 wt-% calcium oxide.

For connecting the refractory bricks, the refractory mortars known to those skilled in the art for this purpose, which possibly can also contain water glass, can be used, and for this purpose there can be used for instance refractory cement M 45 S containing 47 wt-% Al₂O₃, 49 wt-% SiO₂ and 1.0 wt-% Fe₂O₃. For connecting the refractory bricks, 2 to 10 wt-% of refractory mortar are typically used, based on the outer layer. Alternatively, cement-free and low-iron refractory mortars with sol-gel binding can also be used for connecting purposes.

In accordance with another particular embodiment of the present invention, the outer layer contains refractory concrete in addition to or preferably as an alternative to refractory brick, and for this purpose there can be used in particular refractory concrete with a density of 2 to 2.5 kg/dm³ and particularly preferably between 2.1 and 2.4 kg/dm³, and/or containing
50 to 60 wt-% alumina
38 to 44 wt-% silica
0.5 to 1.2 wt-% iron oxide, and
0 to 4.5 wt-% calcium oxide,
   and quite particularly preferably refractory concrete with a density of 2 to 2.5 kg/dm³ and particularly preferably between 2.1 and 2.4 kg/dm³, and containing
57 wt-% alumina
42 wt-% silica
1 wt-% iron oxide, and
0 wt-% calcium oxide.

In accordance with a development of the invention it is proposed that the outer layer of the thermal insulation coating contains 10 to 100 wt-% refractory brick and/or 10 to 100 wt-% refractory concrete, and particularly preferably 70 to 100 wt-% refractory brick or 70 to 100 wt-% refractory concrete, each of the aforementioned compositions.

Preferably, the inner layer contains light-weight refractory brick with a density of 0.4 to 0.8 kg/dm³ and/or light-weight refractory brick containing
30 to 99 wt-% alumina
5 to 95 wt-% silica
0 to 1.5 wt-% iron oxide, and
0 to 16 wt-% calcium oxide,
   particularly good results being achieved with light-weight refractory brick containing
40 wt-% alumina
47 wt-% silica
1 wt-% iron oxide, and
12 wt-% calcium oxide.

In accordance with another particular embodiment of the present invention, the inner layer contains insulating concrete in addition to or preferably as an alternative to light-weight refractory brick. For this purpose, there can in particular be used insulating concrete with a density of 0.4 to 0.8 kg/dm³ and/or containing
30 to 99 wt-% alumina
5 to 95 wt-% silica
0 to 1.5 wt-% iron oxide, and
0 to 16 wt-% calcium oxide
   with the proviso that the content of either iron oxide or calcium oxide is not more than 1.5 wt-%, and quite particularly preferably insulating concrete with a density of 0.4 to 0.8 kg/dm³ and containing
38 wt-% alumina
50 wt-% silica
1.5 wt-% iron oxide, and
10.5 wt-% calcium oxide.

For connecting the light-weight refractory bricks and/or insulating concrete possibly the same materials can be used as for connecting the refractory bricks.

In accordance with a development of the invention it is proposed that the inner layer of the thermal insulation coating contains 10 to 100 wt-% light-weight refractory brick and/or 10 to 100 wt-% insulating concrete and particularly preferably 70 to 100 wt-% light-weight refractory brick or 70 to 100 wt-% insulating concrete, each of the aforementioned compositions.

In particular with thermal insulation coatings of the aforementioned compositions, in which the outer layer has a thickness of 50 to 250 mm, particularly preferably of 100 to 150 mm, and quite particularly preferably of 120 to 130 mm, and/or the inner layer has a thickness of 100 to 400 mm, particularly preferably of 180 to 280 mm, and quite particularly preferably of 220 to 240 mm, and the total thickness of the thermal insulation coating is 50 to 600 mm, particularly preferably 250 to 400 mm, and quite particularly preferably 380 to 420 mm, good results are obtained.

Preferably, in particular in the case of reactors with a diameter of more than 1 m, the thermal insulation coating in accordance with the present invention is attached to the inside of the reactor wall by means of one or more anchors each consisting of a stem and a disk. A particular advantage of this embodiment consists in that the anchor disk of the anchor connected with the reactor wall via the anchor stem can also end in the range of 10 to 120 mm and preferably in the range of 50 to 80 mm below the insulation surface facing away from the inner reactor wall, and there is still achieved a sufficient attachment of the thermal insulation coating to the inner reactor wall. By embedding the anchor into the insulation with an increased dielectric constant as compared to the reactor space, the field strength is attenuated by the dielectric surrounding the anchor, so that undesired field banking is distinctly reduced. Protruding anchor parts or even completely missing insulations should thus be avoided.

To avoid the formation of plasma as a result of field banking, it is furthermore proposed to use anchors of a metal of high electric conductivity, particularly preferably of the material of the reactor shell or of other metallic materials which are designed for the process conditions, such as steel, in particular steel 253 MA (material number: 1.4893), which must necessarily have rounded metal edges. The use of metal needles to reinforce edges or angles possibly should be omitted completely. Particularly useful are anchors which have no gaps between the electrically conductive materials, as otherwise, like for instance in the case of anchors with legs, electric arcs can be formed between the legs of such gap due to potential differences.

To avoid an undesired antenna effect, anchors with a diameter of the anchor disk of 40 to 150 mm should advantageously be used, the length of the anchor stem preferably being 100 to 400 mm and particularly preferably 180 to 240 mm. Furthermore, the thickness of the anchor disk preferably lies in the range between 3 and 50 mm, and particularly preferably between 6 and 12 mm, as the anchors thus are not substantially heated by the microwave field, but can efficiently dissipate the heat produced in the surface by the induced eddy currents.

The disks and stems of the anchors can be connected with each other in any way known to the skilled person, for instance by welding or screwing, electrically conductive connections between the two components as well as those which ensure a smooth, closed surface being preferred, however.

If several anchors are used for attaching the thermal insulation coating to the inner reactor wall, their mutual distance preferably is a multiple of the wavelength of the microwave rays to be introduced plus the single disk diameter. This corresponds to a maximum number of anchors of 9 or 64 pieces per square meter, when microwaves are coupled into the reactor with 915 MHz or 2.45 GHz.

As a means for feeding microwave rays, the fluidized-bed reactor of the invention can in principle include any construction known to those skilled in the art for this purpose, and in particular microwave coupling via a waveguide by simultaneously purging the waveguide with process gas has turned out to be advantageous, as solid deposits in the waveguide, which reduce the cross-section of the waveguide and absorb part of the microwave energy, can reliably be avoided thereby. For this purpose, the means for feeding microwave rays into the reactor preferably comprises a process gas supply conduit apart from a microwave source as well as a waveguide extending through the insulating layer.

Suitable microwave sources include e.g. a magnetron or klystron. There can also be used high-frequency generators with corresponding coils or power transistors. The frequencies of the electromagnetic waves emitted by the microwave source usually lie in the range from 300 MHz to 30 GHz. There are preferably used the ISM frequencies 435 MHz, 915 MHz and 2.45 GHz. Expediently, the optimum frequencies are determined for each application in a trial operation.

In accordance with the invention, the waveguide and the process gas supply conduit are completely made of an electrically conductive material, e.g. copper or steel, in particular steel 253 MA (material number: 1.4893), wherein the length of the waveguide can be varied as desired, but due to power losses should preferably lie below 10 m. The waveguide can be straight or bent. Preferably, there are used sections of round or rectangular cross-section, the dimensions being adjusted in particular to the frequency used.

To achieve a high efficiency when coupling the microwaves into the reactor, it is proposed in accordance with a development of the invention that the waveguide or the waveguides, when using a plurality of waveguides, is (are) inclined by an angle of 5 to 90°, particularly preferably by 5 to 75°, quite particularly preferably by 10 to 20°, and highly preferably by Brewster's angle, with respect to the vertical axis of the reactor. Electromagnetic waves are transverse waves, i.e. have a direction of polarization, the direction of the electric field strength being parallel to the transmitter dipole. To introduce as much microwave energy as possible into the substances to be heat-treated, the reflectance should be minimized. As is known, the reflectance depends on the angle of incidence, on the refractive index of the substance to be excited, and on the direction of polarization. Since the substances to be excited either lie uneven on a grid in the fluidized bed or circulate in the reactor space together with introduced gas, there is no clearly defined surface on which the microwave rays will impinge. When introducing microwaves from several microwave sources, the reflected microwaves form standing waves of multiple modes in the reactor space. These modes are also obtained with microwaves from only one microwave source, as the microwaves are reflected at the wall of the reactor in various directions. These microwaves amplify each other by magnifying the amplitude in some areas and cancel each other in other areas. Thus, a multitude of standing waves is produced. Surprisingly, it was found that in particular with an angle of incidence of the microwaves of 10 to 20 degrees with respect to the vertical axis of the reactor, the smallest reflection and hence the highest efficiency can be achieved.

To prevent a passage of the electromagnetic wave upon entrance into the interior of the reactor via the waveguide into the thermal insulation coating, the orifice region of the waveguide is provided with a preferably substantially ring-shaped diaphragm at the sectional area facing the interior of the reactor, the annular surface preferably having a width corresponding to twice the value of the wavelength of the microwaves to be introduced. Thereby, and because the waveguide as well as the process gas supply conduit are made of an electrically conductive material, a radiation of the microwaves into the reactor is achieved, in which the same are absorbed by the substance to be heat-treated, without the electromagnetic waves running into the insulation coating.

In particular when operating the fluidized-bed reactor with high power densities to be introduced, based on the individual waveguide, it turned out to be advantageous to provide a flared portion in the orifice region of the waveguide at the sectional surface facing the reactor interior, the flared portion preferably including an angle of 10 to 75°, and particularly preferably 20 to 45°, with respect to the longitudinal axis of the waveguide. In this embodiment, the orifice region of the waveguide is also provided with a preferably substantially ring-shaped diaphragm at the sectional surface facing the reactor interior, the annular surface preferably having a width corresponding to twice the value of the wavelength of the microwaves to be introduced. In this way, the formation of plasma at the solid particles of the fluidized bed can reliably be prevented as a result of the high power density in the orifice region of the waveguide at the sectional surface facing the reactor interior.

In particular in the case of applications in which the fluidized-bed reactor is filled with materials having a poor to moderate absorption of microwaves, the diaphragm preferably constitutes a closed cylinder connected with the reactor wall. By means of this flat and closed hollow cylindrical body, which is skew inside corresponding to the angle of inclination of the waveguide, it is achieved that the energy which due to the ring-shaped diaphragm surface has not yet been emitted into the reactor, moves on along the reactor wall and is successively dissipated in the thermal insulation coating, without inducing a field banking at the transition from the diaphragm to the thermal insulation coating.

In accordance with another embodiment of the present invention, a grating with a mesh size of 2×2 mm to 5×5 mm with a thickness of 1 to 5 mm of the grating at 2.45 GHz and 2×2 mm to 15×15 mm with a thickness of 3 to 15 mm of the grating at 916 MHz is provided in the process gas supply conduit. Due to this mesh size it is achieved that the microwave radiation present in the process gas supply conduit is reflected back to the waveguide and hence into the reactor interior, without the flow conditions of the process gas being remarkably influenced by the grating.

### BRIEF DESCRIPTION OF THE DRAWINGS

FIG. 1 shows a schematic view of the fluidized-bed reactor in accordance with an embodiment of the present invention;

FIG. 2 shows a schematic view of the attachment of the thermal insulation coating to the reactor wall by means of an anchor in accordance with an embodiment of the present invention;

FIG. 3 shows a schematic cross-section of the means for feeding microwave radiation into the fluidized-bed reactor in accordance with a first embodiment of the present invention;

FIG. 4 shows the schematic cross-section of the means for feeding microwave radiation into the fluidized-bed reactor in accordance with a second embodiment of the present invention;

FIG. 5 shows the schematic cross-section of the means for feeding microwave radiation into the fluidized-bed reactor in accordance with a third embodiment of the present invention;

FIG. 6 shows the schematic cross-section of the means for feeding microwave radiation into the fluidized-bed reactor in accordance with a fourth embodiment of the present invention.

### DESCRIPTION OF THE PREFERRED EMBODIMENTS

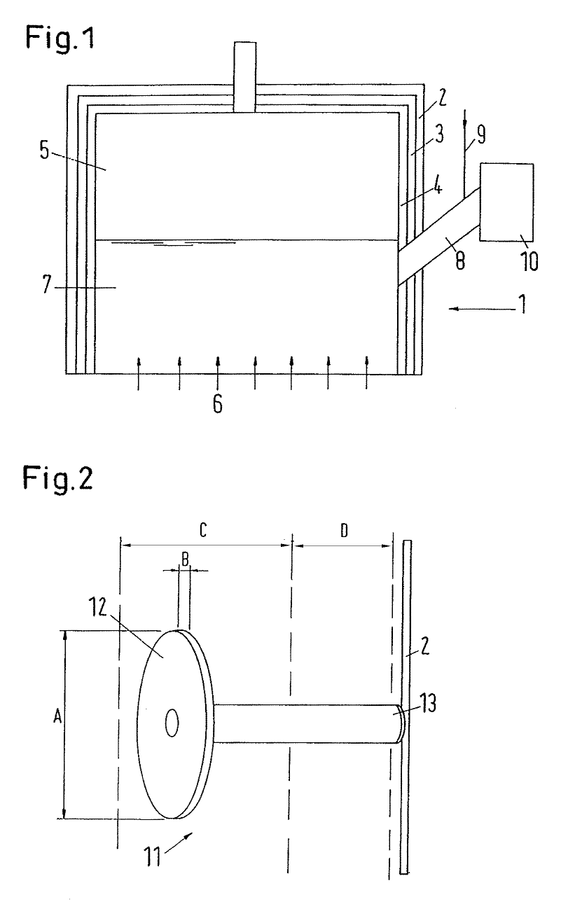

The fluidized-bed reactor 1 as shown in FIG. 1 is defined by a reactor wall 2, on whose inside a thermal insulation coating consisting of two layers is provided, whose inner layer 3 as seen from the reactor wall 2 is made of light-weight refractory brick and whose outer layer 4 is made of refractory brick. The two-layer thermal insulation coating 3, 4 is connected with the reactor wall 2 via a functional mineral binding layer, which compensates possible stresses resulting from the different thermal expansions of the thermal insulation on the one hand and from the reactor shell on the other hand and contains less than 2 wt-% FeO and CaO (not shown). The arrangement formed of the reactor wall 1, the binding layer and the two layers 3, 4 of the thermal insulation coating defines the reactor interior 5, in whose lower part a fluidized bed 7 is formed, which is produced and maintained by injecting fluidizing air via corresponding supply conduits 6. During operation of the reactor 1, microwaves are supplied to the reactor interior 5 for heating the solids constituting the fluidized bed 7 via a means which comprises a waveguide 8 extending through the reactor wall 2, the binding layer and the thermal insulation coating 3, 4, a process gas supply conduit 9, and a microwave source 10.

The anchor 11 shown in FIG. 2, which is either provided alone or in addition to a binding layer for attaching the thermal insulation coating 3, 4 to the reactor wall 2, consists of a substantially cylindrical anchor disk 12 and an anchor stem 13, which are both made of an electrically conductive material and are electrically connected with each other. To avoid an undesired antenna effect, the anchor disk 12 has a diameter A between 40 and 150 mm as well as a thickness B between 3 and 50 mm. The anchor stem 13 of round cross-section, which is connected with the inner reactor wall, extends through the layers 4, 3 of the thermal insulation coating, which have a layer thickness C, D, the anchor disk preferably ending 50 to 80 mm below the surface of the insulating layer.

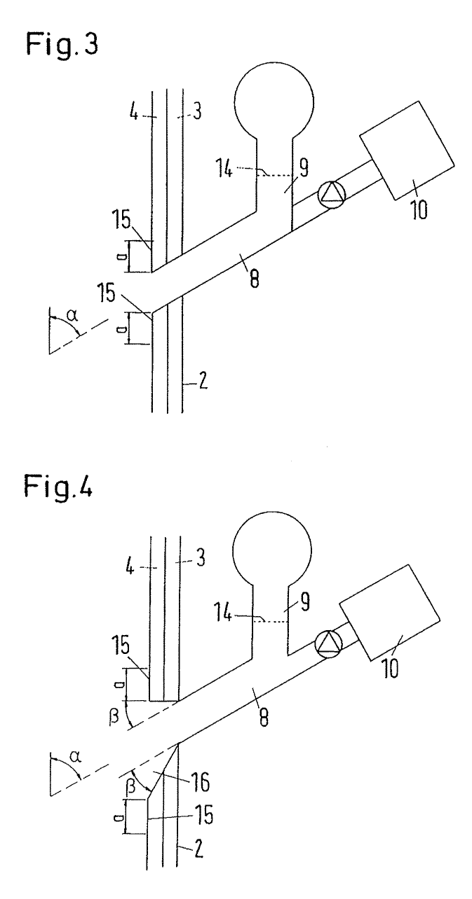

The means for feeding microwaves into the fluidized-bed reactor 1, which are shown in FIGS. 3 to 6, each comprise a waveguide 8 extending through the reactor wall 2 and the thermal insulation coating consisting of the two layers 3, 4, a microwave source 10, and a process gas supply conduit 9. Via the waveguide 8, which is flushed by the process gas supplied via the process gas supply conduit 9 to avoid solid deposits in the waveguide 8, the microwaves emitted by the microwave source 10 enter the reactor interior 5, where the same heat the substance to be heat-treated after having been absorbed. To ensure an efficient coupling of the microwaves into the reactor, the waveguide 8 is inclined with respect to the vertical axis of the reactor by the angle (α). In the process gas supply conduit 9 a substantially horizontally arranged grating 14 is provided, which has a mesh size which ensures a reflection of the microwave radiation present in the process gas supply conduit 9 back into the waveguide 8 and hence into the reactor interior 5, without the flow conditions of the process gas being remarkably influenced by the grating 14.

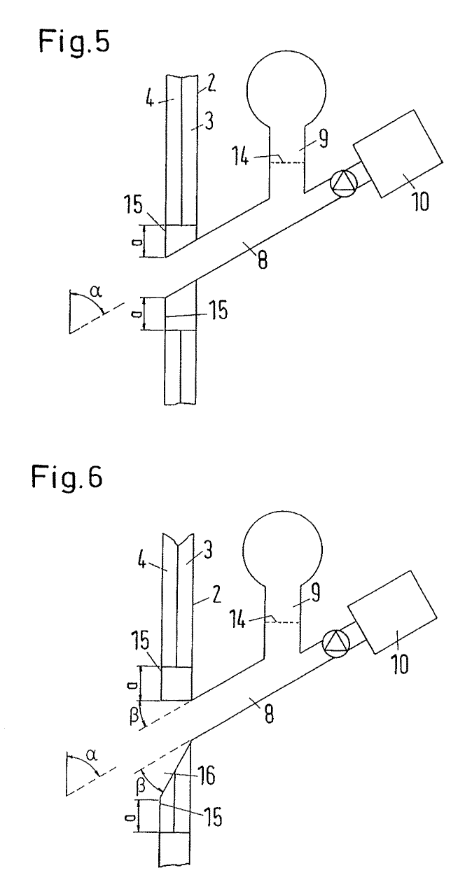

In all embodiments shown in FIGS. 3 to 6, a diaphragm 15 of electrically conductive material is provided in the orifice region of the waveguide 8 at the sectional surface facing the reactor interior 5, which diaphragm has an annular cross-section with a width of the annular surface preferably corresponding to twice the wavelength of the introduced microwaves. Since the waveguide 8, the process gas supply conduit 9 and the reactor wall 2 are also made of an electrically conductive material, there is thus achieved a radiation of the microwaves into the reactor 1, in which the same are absorbed by the substance to be heat-treated, without the electromagnetic waves running into the insulation coating 3, 4. As shown in FIGS. 5 and 6, the diaphragm 15 constitutes a closed cylinder connected with the reactor wall 2, through whose middle the waveguide 8 extends. Such design of the diaphragm 15 is advantageous in particular in applications in which the fluidized-bed reactor is filled with materials having a poor to moderate absorption of microwaves, as it is thus achieved that the energy which has not yet been emitted into the reactor by the ring-shaped diaphragm surface moves on along the reactor wall and is successively dissipated in the thermal insulation coating, without inducing field banking at the transition from the diaphragm to the thermal insulation coating.

In contrast to the embodiments shown in FIGS. 3 and 5, the fluidized-bed reactors 1 as shown in FIGS. 4 and 6 include a flared portion 16 in the orifice region of the waveguide 8 at the sectional surface facing the reactor interior 5, which flared portion preferably includes an angle (β) of 10 to 75° and particularly preferably of 20 to 45°, with respect to the longitudinal axis of the waveguide 8. This design is advantageous in particular when operating the fluidized-bed reactor 1 with high power densities to be introduced, based on the individual waveguide 8, as thereby the formation of plasma at the solid particles of the fluidized bed 7 in the orifice region of the waveguide 8 at the sectional surface facing the reactor interior 5 as a result of the high power density can reliably be prevented.

### LIST OF REFERENCE NUMERALS

1 fluidized-bed reactor
2 reactor wall
3 inner layer of the thermal insulation coating
4 outer layer of the thermal insulation coating
5 reactor interior
6 supply conduits for fluidizing air
7 fluidized bed
8 waveguide
9 process gas supply conduit
10 microwave source
11 anchor
12 anchor disk
13 anchor stem
14 grating
15 diaphragm
16 flared portion
A diameter of the anchor disk
B thickness of the anchor disk
C thickness of the outer layer of the thermal insulation coating
D thickness of the inner layer of the thermal insulation coating

1. A fluidized-bed reactor for the thermal treatment of fluidizable substances, comprising at least one means for feeding microwave radiation into the fluidized-bed reactor and a metallic reactor wall defining the reactor and having a thermal insulation coating, wherein the thermal insulation coating is provided on the inside of the reactor wall and has an outer layer as seen from the reactor wall, which comprises refractory brick and/or refractor concrete, as well as an inner layer comprising light-weight refractory brick and/or insulating concrete, and the thermal insulation coating.

2. The fluidized-bed reactor as claimed in claim 1, wherein the thermal insulation coating is provided directly on the inside reactor wall, on a binding layer or on a layer of aluminum silicate or calcium silicate disposed on the inside reactor wall or the binding layer.

3. The fluidized-bed reactor as claimed in claim 1, wherein the outer layer comprises refractory brick with a density of 2.2 to 2.6 kg/dm³ and/or refractory brick containing
40 to 50 wt-% alumina
45 to 55 wt-% silica
1.5 to 2.2 wt-% iron oxide, and
0 to 1 wt-% calcium oxide
and particularly preferably refractory brick containing
45 wt-% alumina
53 wt-% silica
2 wt-% iron oxide, and
0 wt-% calcium oxide.

4. The fluidized-bed reactor as claimed in claim 1, wherein the outer layer comprises refractory concrete with a density of 2 to 2.5 kg/dm³, particularly preferably between 2.1 and 2.4 kg/dm³, and/or containing
50 to 60 wt-% alumina
38 to 44 wt-% silica
0.5 to 1.2 wt-% iron oxide, and
0 to 4.5 wt-% calcium oxide,
and particularly preferably refractory concrete containing
57 wt-% alumina
42 wt-% silica
1 wt-% iron oxide, and
0 wt-% calcium oxide.

5. The fluidized-bed reactor as claimed in claim 1, wherein the outer layer of the thermally insulating coating contains 10 to 100 wt-% refractory brick and/or 10 to 100 wt-% refractory concrete and particularly preferably 70 to 100 wt-% refractory brick or 70 to 100 wt-% refractory concrete.

6. The fluidized-bed reactor as claimed in claim 1, wherein the inner layer comprises light-weight refractory brick with a density of 0.4 to 0.8 kg/dm³ and/or light-weight refractory brick containing
30 to 99 wt-% alumina
5 to 95 wt-% silica
0 to 1.2 wt-% iron oxide, and
0 to 16 wt-% calcium oxide,
and particularly preferably light-weight refractory brick containing
40 wt-% alumina
47 wt-% silica 1 wt-% iron oxide, and
12 wt-% calcium oxide.

7. The fluidized-bed reactor as claimed in claim 1, wherein the inner layer comprises insulating concrete with a density of 0.4 to 0.8 kg/dm³ and/or containing
30 to 99 wt-% alumina
5 to 95 wt-% silica
0 to 1.5 wt-% iron oxide, and
0 to 16 wt-% calcium oxide
with the proviso that the content of either iron oxide or calcium oxide is not more than 1.5 wt-%, and particularly preferably insulating concrete containing
38 wt-% alumina
50 wt-% silica
1.5 wt-% iron oxide, and
10.5 wt-% calcium oxide.

8. The fluidized-bed reactor as claimed in claim 1, wherein the inner layer of the thermal insulation coating contains 10 to 100 wt-% fight-weight refractory brick and/or 10 to 100 wt-% insulating concrete and particularly preferably 70 to 100 wt-% light-weight refractory brick or 70 to 100 wt-% insulating concrete.

9. The fluidized-bed reactor as claimed in claim 1, wherein the outer layer has a thickness of 50 to 250 mm, particularly preferably of 100 to 150 mm, and quite particularly preferably of 120 to 130 mm, and/or the inner layer has a thickness of 100 to 400 mm, particularly preferably of 180 to 280 mm and quite particularly preferably of 220 to 240 mm, and the total thickness of the thermal insulation coating is 50 to 600 mm, particularly preferably 250 to 400 mm, and quite particularly preferably 380 to 420 mm.

10. The fluidized-bed reactor as claimed in claim 1, wherein the thermal insulation coating is attached to the inside of the reactor wall by means of at least one anchor consisting of a stem and a disk.

11. The fluidized-bed reactor as claimed in claim 10, wherein the anchor stem is connected with the inside reactor wall and the anchor disk ends 10 to 120 mm, and preferably 50 to 80 mm below the insulation surface.

12. The fluidized-bed reactor as claimed in claim 10, wherein the anchor is made of metal, preferably of the material of the reactor shell, and has rounded metal edges.

13. The fluidized-bed reactor as claimed in claim 10, wherein the anchor disk has a diameter of 40 to 150 mm and/or a thickness between 3 and 50 mm and particularly preferably between 6 and 12 mm and/or the anchor stem has a length of 100 to 400 mm and particularly preferably of 180 to 240 mm.

14. The fluidized-bed reactor as claimed in claim 10, wherein the anchor disk is electrically connected with the anchor stem.

15. The fluidized-bed reactor as claimed in claim 10, wherein the individual anchors are arranged at a distance corresponding to the multiple of the wavelength of the microwave rays to be introduced plus the single disk diameter.

16. The fluidized-bed reactor as claimed in claim 1, wherein that the means for feeding microwave rays into the reactor comprises a microwave source, a process gas supply conduit as well as a waveguide extending through the insulating layer, the waveguide being inclined by an angle of 5 to 90° particularly preferably of 5 to 75° quite particularly preferably of 10 to 20° and highly preferably by Brewster's angle with respect to the vertical axis of the reactor.

17. The fluidized-bed reactor as claimed in claim 16, wherein at the sectional surface facing the reactor interior the orifice region of the waveguide is provided with a preferably substantially ring-shaped diaphragm, the annular surface preferably having a width corresponding to twice the value of the wavelength of the microwaves to be introduced.

18. The fluidized-bed reactor as claimed in claim 16, wherein at the sectional surface facing the reactor interior in the orifice region of the waveguide a flared portion is provided, the flared portion preferably including an angle of 10 to 75° and particularly preferably of 20 to 45° with respect to the longitudinal axis of the waveguide.

19. The fluidized-bed reactor as claimed in claim 16, wherein the diaphragm constitutes a closed cylinder connected with the reactor wall.

20. The fluidized-bed reactor as claimed in claim 16, wherein a grating with a mesh size of 2×2 mm to 5×5 mm with a thickness of 1 to 5 mm of the grating at 2.45 8 Hz and 2×2 mm to 15×15 mm with a thickness of 3 to 15 mm of the grating at 915 MHz is provided in the process gas supply conduit.
